(19) United States
(12) Patent Application Publication
(10) Pub. No.: US 2011/0220236 A1
(43) Pub. Date: Sep. 15, 2011

(54) TWO-LAYERED PLASTIC TUBING PIECE FOR PRESSURIZED FLUID CONDUITS

(75) Inventors: Ralph KETTL, Paspels (CH); Mark PFLEGHAR, Domat/Ems (CH)

(73) Assignee: EMS-PATENT AG, Domat/Ems (CH)

(21) Appl. No.: 13/047,413

(22) Filed: Mar. 14, 2011

(30) Foreign Application Priority Data
Mar. 15, 2010 (EP) 10156529.9
Feb. 7, 2011 (EP) 11153562.1

(51) Int. Cl. F16L 11/20

(52) U.S. Cl. 138/137

(57) ABSTRACT

The invention relates to a two-layered plastic tubing piece for pressurized fluid conduits comprising an inner layer and an outer layer. The inner layer is formed from a first mixture comprising an elastomeric co-polyolefin or a blend of a partially crystalline polyolefin and a synthetic olefin rubber, as well as a homopolyamide. The outer layer is formed from a second mixture comprising a homopolyamide. According to the invention, both mixtures of the inner layer and the outer layer comprise the same homopolyamide wherein an impact modifier from the class of acid-modified ethylene-α-olefin copolymers is added to each of these mixtures and wherein the homopolyamide has a melting point of above 200° C. and has an average of at least 8 C atoms per monomer unit. The two-layered plastic tubing piece according to the invention is preferably formed as a fluid conduit for automobiles, in particular as a cooling line for automobiles.

### RELATED PATENT APPLICATIONS

The present patent application claims priority of the European patent application No. 10 156 529.9 of Mar. 15, 2010 and of the European patent application No. 11 153 562.1 of Feb. 7, 2011. The entire content of these prior applications is incorporated herein by explicit reference for any purpose.

### RELATED FIELD OF TECHNOLOGY

The invention relates to a two-layered plastic tubing piece for pressurized fluid conduits comprising an inner layer and comprising an outer layer. The inner layer is formed from a first mixture comprising an elastomeric co-polyolefin or a blend of a partially crystalline polyolefin and a synthetic olefin rubber, as well as a homopolyamide. The outer layer is formed from a second mixture comprising a homopolyamide. Such tubings or pipes are used inter alia in industry and in automobile manufacture; preferred here are cooling lines for automobiles.

### RELATED PRIOR ART

An economical system of cooling liquid conduits (design according to EMS-CHEMIE AG, Domat/Ems, Switzerland) has been known for some time under the name ECOSYS, these cooling liquid conduits consisting of thermoplastics instead of rubber. In order to achieve the same flexural flexibility as in the conventional rubber tubings, the plastic tubings (made of somewhat harder material) are frequently designed to be corrugated in sections. The plastic cooling liquid conduits usually have two or three layers, wherein the inner layer must be hydrolysis-resistant to the hot water/glycol mixture in the engine cooling circuit.

The outer layer must offer protection from external influences (e.g. mechanical protection against impact) and must be chemically resistant (e.g. to road salt in winter). In addition, such a tubing as a whole must be resistant to bursting pressure (because the cooling circuit is under a fluid internal pressure) and in addition must also withstand for a long time the high temperatures of the cooling fluid and the ambient air temperatures in the vicinity of the engine.

Polyolefins (having sufficient temperature resistance) are primarily considered as the inner layer, advantageously those exhibiting a certain elastomeric behavior, e.g. elastomeric co-polyolefins or blends of partially crystalline polyolefins (e.g. polypropylene=PP) and synthetic olefin rubbers (e.g. ethylene propylene diene rubber=EPDM). The elasticity gives a sealing function when placing the hoses on the connecting pieces.

A suitable class of polyolefin elastomers are blends of PP and EPDM, the EPDM preferably being cross-linked. Such blends are available, for example, under the trade name Santoprene™ (trade name of the Exxon Mobil Corp. Irving, Tex. 75039, USA). As the case may be, such blends as special types can contain adhesion-promoting or functionalized additives so that they adhere, for example, to polyamide.

Multilayer plastic pipes comprising polyamides are known and are used in vehicle construction for example for cooling lines of automobiles:

According to DE 44 28 236 C1, these multilayer tubings for fluids comprise an outer polyamide layer and an inner plastic layer made of a modified thermoplastic elastomer having a fully cross-linked rubber phase, e.g. EPBM. The adhesion promoter usually joining these two layers (i.e. the adhesion promoter layer) can, according to DE 44 28 236 C1, be omitted as a result of the elastomer of the inner plastic layer containing a copolymer of a functionalized polyolefin as the main component and a polyamide.

According to EP 1 362 890 A1, such a pressurized fluid conduit can be configured to be smooth or have at least partially corrugated walls so that it forms a corrugated multilayer polymer tubing having reduced length variation. This pressurized fluid conduit preferably comprises a so-called “hard-soft combination” with an outer layer of a harder polymer or a polymer mixture and having an inner layer of a rubber-elastic polymer or a polymer mixture. These fluid conduits are preferably produced by co-extrusion, wherein the two layers adhere directly and in a resistant manner to one another without additional adhesion promoters or adhesion promoter layers (such as are known, for example, from EP 0 745 898 B1).

The German unexamined laid-open patent application DE 101 16 427 A1 discloses a multilayer hose for a motor vehicle cooling system comprising at least two layers, wherein the material for the inner layer is a mixture containing a polymer having a carboxyl group and/or a derivative thereof and a thermoplastic elastomer having a carboxyl group and/or a derivative thereof. The thermoplastic elastomer is a dynamically cross-linked olefin elastomer having fractions of ethylene-o-olefin copolymers of ethylene and an a-olefin having 3 to 12 carbon atoms. In addition, the thermoplastic elastomer contains fractions of a propylene resin. The material of the outer layer comprises a thermoplastic polyamide resin.

In the known ECOSYS 2 system (design according to EMS-CHEMIE AG, Domat/Ems, Switzerland), the outer layer of a two-layer cooling fluid conduit consists of polyamide 12 (PA 12) and the inner layer consists of a Santoprene elastomer (cf. also EP 1 362 890 A1). However, this solution no longer satisfies the higher requirements which arise from a long-term usage temperature of the air in particular surrounding newer engines of >125° C.

The precise operating conditions known, for example, from the PSA Standard B22 6142 (PEUGEOT-CITROEN) dated 5 Aug. 2004 and the resulting temperature classes are reproduced in the following Table 1 (cf. table page 11/26 of this standard).

TABLE 1
PSA Standard B22 6142:

| | | | Environment | | | | | | | | |
|---|---|---|---|---|---|---|---|---|---|---|---|
| | | | Air temperature | | | | | | | | |
| Coolant | | | | | | | | | | | Temper- |
| | Coolant | | | | | | | | | | ature |
| | temperature | | 100 | 110 | 125 | 135 | 150 | 165 | 175 | 200 | class |
| Contin- | 95% | 95° C. | 100 | 110 | 125 | 135 | 150 | 165 | 175 | 200 | Ambi- |
| uous | | | | | | | | | | | ent |
| | | | | | | | | | | | temper- |
| | | | | | | | | | | | ature |
| Peak | 4% | 118° C. | 125 | 125 | 150 | 150 | 175 | 175 | 200 | 225 | Peak |
| value | | | | | | | | | | | temper- |
| 1 | | | | | | | | | | | ature- |
| Peak | 1% | 136° C. | 125 | 125 | 150 | 150 | 175 | 175 | 200 | 225 | |
| value | | | | | | | | | | | |
| 2 | | | | | | | | | | | |

Here the ambient temperature designates an external temperature to which the cooling lines are exposed during 99% of their lifetime. The peak temperature designates an external temperature to which the cooling lines are exposed during 1% of their lifetime. The validation of one class requires the validation of all lower temperature classes for the same material, wherein classes 125 and 150 are normally considered to be the most important classes.

### OBJECT AND SUMMARY OF THE INVENTION

The object of the present invention is to propose a two-layered plastic tubing piece for pressurized fluid conduits which meets the requirements of the 150° C. temperature class.

This object is achieved by the features as herein disclosed: a two-layered plastic tubing piece for pressurized fluid conduits comprises an inner layer and an outer layer. The inner layer is formed from a first mixture comprising an elastomeric co-polyolefin or a blend of a partially crystalline polyolefin and a synthetic olefin rubber, as well as a homopolyamide. The outer layer is formed from a second mixture comprising a homopolyamide. The two-layered plastic tubing piece for pressurized fluid conduits according to the invention is characterized in that both mixtures from which the inner layer and the outer layer are formed, comprise the same homopolyamide and that an impact modifier from the class of acid-modified ethylene-α-olefin copolymers is added to each of these mixtures, wherein the homopolyamide has a melting point of above 200° C. and has an average of at least 8 C atoms per monomer unit.

Further preferred and inventive features are obtained from the dependent claims.

The two-layered plastic tubing piece for pressurized fluid conduits according to the invention comprises the following advantages:
The two layers of the two-layered plastic tubing are both formed from a mixture which each comprises the same homopolyamide and an impact modifier from the class of acid-modified ethylene-a-olefin copolymers. Thanks to these components common to both layers, these two layers adhere well to one another without an additional adhesion promoter needing to be added or an additional adhesion promoter layer disposed between the inner and outer layer.
The particularly preferably used polyamide PA 612 has a higher melting point compared with the polyamide PA 12 previously used as the outer layer (215° C. instead of 178° C.), which increases the temperature resistance compared with the conventionally used outer layers of PA 12.
Compared with the polyamide PA 6 which has a similar melting point and is possibly also considered, the particularly preferred PA 612 additionally has the advantage that as a result of the higher average number of C atoms per monomer unit (and the increased hydrophobia as a result), it is largely hydrolysis-resistant and therefore can also be used as a material component in the inner layer.

In addition to the particularly preferred PA 612, suitable preferred polyamides within the framework of the specification of claim 1 for which the aforesaid advantages also apply are also PA 610, PA 614 and PA 616.

The impact modifier is preferably present in the mixture from which the inner layer is formed in a fraction of 2-55 wt. %, more preferably in a fraction of 15-45 wt. % and particularly preferably in a fraction of 25-35 wt. %, in each case relative to 100 wt. % of the mixture. An impact modifier content of the mixture for the inner layer of 30 wt. % is quite especially preferred.

The impact modifier is preferably present in the mixture from which the outer layer is formed in a fraction of 1-50 wt. %, more preferably in a fraction of 10-30 wt. % and particularly preferably in a fraction of 15-25 wt. %, in each case relative to 100 wt. % of the mixture. An impact modifier content of the mixture for the outer layer of 20 wt. % is quite especially preferred.

Suitable impact modifiers for polyamide molding compounds are known to the person skilled in the art, for example, from EP 0 654 505 B1, where various classes of impact modifiers are described in Paragraphs [0035] to [0052].

The impact modifier from the class of acid-modified ethylene-a-olefin copolymers in both mixtures from which the inner layer and the outer layer are formed is preferably an ethylene propylene/ethylene butylene copolymer grafted with MAH (MAH is the abbreviation for maleic acid anhydride). The corresponding product TAFMER MC201 (Mitsui Chemicals Inc., Tokyo, Japan) is especially preferred as an impact modifier. In TAFMER MC201 the grafted MAH content is 0.5 to 0.7 wt. %, the EP (ethylene propylene) copolymer fraction is 65-70 wt. % and the EB (ethylene butylene) copolymer fraction is 30-35 wt. %; in addition, the MFR value (melt flow rate) measured at 230° C. and 2.16 kg weight is preferably between 1.2 and 1.4 g/10 min.

The homopolyamide in both mixtures from which the inner layer and the outer layer are formed is preferably in particular the polyamide PA 612. This homopolyamide has the following structural formula:

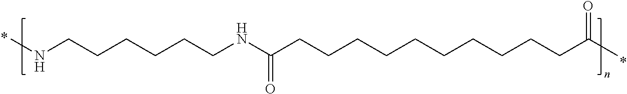

where PA 612 has an average of 9 C atoms per monomeric unit. In connection with the present invention, the term “average number of C atoms per monomeric unit” is understood as the number of C atoms which is calculated from the total of the number of C atoms in the monomers used, divided by the number of monomers used. PA 612 is the polycondensation product of 1,6-hexamethylene diamine and 1,12-dodecanoic diacid. That is, the average number of C atoms per monomeric unit is calculated for PA 612 as (6+12):2=9.

The selected homopolyamide in the mixture from which the inner layer is formed is preferably present in a fraction of 2-55 wt. %, more preferably in a fraction of 15-45 wt. %, and particularly preferably in a fraction of 25-35 wt. %. Quite especially preferred is a content of homopolyamide in the mixture for the inner layer of 30 wt. %, in each case relative to 100 wt. % of the mixture.

The selected homopolyamide in the mixture from which the outer layer is formed is preferably present in a fraction of at least 55 wt. %, more preferably in a fraction of at least 65 wt. %, and particularly preferably in a fraction of at least 75 wt. %, in each case relative to 100 wt. % of the mixture. Quite especially preferred is a content of homopolyamide in the mixture for the outer layer of 77.8 wt. %.

Preferably EPM comes into consideration (=co-polyolefin of ethylene and propylene) when using an elastomeric co-polyolefin for the inner layer. Alternatively a blend of a partially crystalline polyolefin and a synthetic olefin rubber is used, wherein a synthetic olefin rubber is understood in the present invention as a cross-linkable elastomeric co-polyolefin.

The synthetic olefin rubber is preferably EPDM which is preferably present in cross-linked form. In a preferred composition EPDM contains between 55 and 75 wt. % ethylene and between 2 and 12 wt. % diene, and propylene. The preferred diene fraction corresponds to a fraction of 3-16 double bonds per 1000 C atoms. In addition, it is preferred that the partially crystalline polyolefin is polypropylene (PP). Particularly preferably, the blend of a partially crystalline polyolefin and a synthetic olefin rubber in the mixture from which the inner layer is formed is an EPDM/PP blend. Such blends are available under the trade name Santoprene™, wherein Santoprene™ 101-80 and/or Santoprene™ 121-75 M100 and/or Santoprene™ 121-80 M100 are quite especially preferred and are all well suited for the present invention.

Thermoplastic molding compounds having a certain similarity to the inner layer material in the present case are also disclosed in EP 0 753 027 B1. However, PA 6, PA 66 and PA 12 are named there as preferred polyamide components (cf. page 6, line 35), that is those homopolyamides which do not meet the specific requirements for the selected homopolyamides of the present invention. The preferred polyamides for the outer layer according to the present invention were also not recognized in EP 0 753 027 B1.

Preferably, the elastomeric co-polyolefin or the blend of a partially crystalline polyolefin and a synthetic olefin rubber (for example, Santoprene™ 101-80 or Santoprene™ 121-75 M100 or Santoprene™ 121-80 M100) in the mixture from which the inner layer according to the invention is formed, is present in a fraction of 10-70 wt. %, more preferably in a fraction of 20-60 wt. %, and particularly preferably in a fraction of 30-50 wt. %, in each case relative to 100 wt. % of the mixture. Quite especially preferred is a content of Santoprene™ 101-80 (or Santoprene™ 121-75 M100 or Santoprene™ 121-80 M100) in the mixture for the inner layer of about 40 wt. %.

### DETAILED DESCRIPTION OF THE INVENTION

The present invention will now be explained in detail with reference to preferred embodiments and examples of the two-layered plastic tubing piece according to the invention and corresponding test results. The examples serve to illustrate the invention and should not be understood as restrictive.

Test pieces of the two-layered plastic tubing piece according to the invention were produced, the mixture for the inner layer comprising:

TABLE 2A
inner layer:

| | | |
|---|---|---|
| Homopolyamide | PA 612 | 30.0 wt. % |
| Impact modifier | TAFMER MC201 | 30.0 wt. % |
| Blend of partially crystalline | SANTOPRENE ™ 101-80 | 39.4 wt. % |
| poly-olefin and synthetic | | |
| olefin rubber | | |
| Antioxidant | HOSTANOX PAR24 | 0.1 wt. % |
| Antioxidant | IRGANOX 1098 | 0.5 wt. % |
| Total | | 100 wt. % |

The mixture for the outer layer comprised:

TABLE 2B
outer layer:

| | | |
|---|---|---|
| Homopolyamide | PA 612 | 77.8 wt. % |
| Impact modifier | TAFMER MC201 | 20.0 wt. % |
| Heat stabilizer | CuI | 0.05 wt. % |
| Stabilizer | KI/Ca-STEARATE 98/2 | 0.3 wt. % |
| Heat stabilizer | BRÜGGOLEN H 20 | 0.5 wt. % |
| Antioxidant | IRGANOX MD1024 | 0.6 wt. % |
| EUTHYLENSCHWARZ | Black color | 0.75 wt. % |
| 00-6005C4 | | |
| Total | | 100 wt. % |

No reinforcements by fillers were introduced into the test pieces.

In order to check the thermo-oxidative resistance of the individual test products based on the polyamide PA 612 and of the Santoprene material, standardized tensile test specimens produced therefrom were placed in a furnace at different temperatures for a fairly long time. Samples were removed from the furnace at various times and then tested for the heat ageing behavior in tensile tests. Of particular interest was a possible reduction of the mechanical values (tensile modulus on the one hand and tearing strength on the other hand) which was measured on the dry tensile test specimens in accordance with ISO Standard 527.

TABLE 3
Heat ageing at 130° C.:

| | Tensile modulus [MPa] | | |
|---|---|---|---|
| Time [h] | Outer layer black | Inner layer black | Santoprene ™ black |
| 0 | 1516 | 166 | 86 |
| 8 | 1437 | 158 | 70 |
| 48 | — | — | — |
| 150 | 1536 | 181 | 90 |
| 500 | 1500 | 206 | 152 |
| 1000 | 1587 | 218 | 178 |
| 0 | 100% | 100% | 100% |
| 8 | 95% | 95% | 81% |
| 48 | — | — | — |
| 150 | 101% | 109% | 105% |
| 500 | 99% | 124% | 177% |
| 1000 | 105% | 131% | 207% |

The remark “black” relates to the appearance of the test pieces, originating from the black coloration. The materials can generally also contain soot.

TABLE 4
Heat ageing at 150° C.:

| | Tensile modulus [MPa] | | |
|---|---|---|---|
| Time [h] | Outer layer black | Inner layer black | Santoprene ™ black |
| 0 | 1516 | 166 | 86 |
| 8 | 1437 | 134 | 92 |
| 48 | — | — | — |
| 150 | 1536 | 166 | 94 |
| 500 | 1530 | 251 | 168 |
| 1000 | 1648 | 140 | 273 |
| 0 | 100% | 100% | 100% |
| 8 | 95% | 81% | 107% |
| 48 | — | — | — |
| 150 | 101% | 100% | 109% |
| 500 | 101% | 151% | 195% |
| 1000 | 109% | 84% | 317% |

It is striking that all the tested layer materials tolerated well storage for over 1000 hours at a temperature of 130° C. or 150° C.

TABLE 5
Heat ageing at 170° C.:

Tensile modulus [MPa]

| Time [h] | Outer layer black | Inner layer black |
|---|---|---|
| 0 | 1516 | 166 |
| 8 | 1426 | 213 |
| 48 | — | — |
| 150 | 1605 | 114 |
| 500 | 1603 | 177 |
| 1000 | 1725 | 175 |
| 0 | 100% | 100% |
| 8 | 94% | 128% |
| 48 | — | — |
| 150 | 106% | 69% |
| 500 | 106% | 107% |
| 1000 | 114% | 105% |

Even at 170° C. the tested layer materials tolerated storage for over 1000 hours (the elastic modulus for the inner layer after 150 hours was clearly an outlier). In the case of Santoprene™, however, this measurement could no longer be made separately because Santoprene™ has a melting point of about 162° C. and is therefore molten.

From these results, it can be concluded that pressurized fluid conduits manufactured in accordance with the two-layered plastic tubing pieces according to the invention can withstand short-term peak temperatures of 175° C. and therefore meet the requirements of temperature class 150 of the PSA Standard B22 6142.

TABLE 6
heat ageing at 130° C.:

| | Tearing strength [MPa] | | |
|---|---|---|---|
| Time [h] | Outer layer black | Inner layer black | Santoprene ™ black |
| 0 | 41 | 13 | 8 |
| 8 | 39 | 13 | 8 |
| 48 | — | — | — |
| 150 | 38 | 14 | 8 |
| 500 | 36 | 14 | 8 |
| 1000 | 37 | 15 | 8 |
| 0 | 100% | 100% | 100% |
| 8 | 95% | 100% | 100% |
| 48 | — | — | — |
| 150 | 93% | 108% | 100% |
| 500 | 88% | 108% | 100% |
| 1000 | 90% | 115% | 100% |

It is striking that all the tested layer materials tolerated well storage for over 1000 hours at a temperature of 130° C.

TABLE 7
Heat ageing at 150° C.:

| | Tearing strength [MPa] | | |
|---|---|---|---|
| Time [h] | Outer layer black | Inner layer black | Santoprene ™ black |
| 0 | 41 | 13 | 8 |
| 8 | 38 | 13 | 7 |
| 48 | — | — | — |
| 150 | 38 | 14 | 7 |
| 500 | 36 | 6 | 4 |
| 1000 | 37 | 6 | 3 |
| 0 | 100% | 100% | 100% |
| 8 | 93% | 100% | 88% |
| 48 | — | — | — |
| 150 | 93% | 108% | 88% |
| 500 | 88% | 46% | 50% |
| 1000 | 90% | 46% | 38% |

It is striking that the tested layer materials (except for Santoprene™) tolerated really well storage for over 1000 hours at a temperature of 150° C. The inner layer is still in the acceptable range.

TABLE 8
Heat ageing at 170° C.:

| | Tensile modulus [MPa] | |
|---|---|---|
| Time [h] | Outer layer black | Inner layer black |
| 0 | 41 | 13 |
| 8 | 40 | 12 |
| 48 | — | — |
| 150 | 35 | 7 |
| 500 | 37 | 4 |
| 1000 | 45 | 4 |
| 0 | 100% | 100% |
| 8 | 98% | 92% |
| 48 | — | — |
| 150 | 85% | 54% |
| 500 | 90% | 31% |
| 1000 | 110% | 31% |

It is striking that now, not all the tested layer materials tolerate storage for over 1000 hours at a temperature of 170° C. For short-term peak temperatures of this order of magnitude, however, the result of the inner layer is still sufficient. For the reason specified above, Santoprene™ could not be measured separately at this temperature because its melting point lies below 170° C.

In addition, results with complete two-layer plastic pipes according to the present invention in accordance with the 150° C. class are provided, which is hereinafter called ECOSYS C150:

TABLE 9
plastic pipes:
ECOSYS C150 Two-layer

| | | | 750 h at | 1000 h |
|---|---|---|---|---|
| | Original | 500 h at | 95° C./ | under extreme |
| Test | pipe | 95° C./150° C. | 150° C. | conditions |
| Adhesion test | ok | ok | ok | ok |
| Impact cold | ok | ok | ok | ok |
| Tightness at | — | ok | ok | ok |
| 23° C./3 bar | | | | |
| Tightness at | ok | ok | ok | ok |
| 136° C./3 bar | | | | |
| Bursting pressure | 7.3 | 6.6 | 6.7 | 7.5-8.2 |
| at 136° C. [bar] | | | | |
| Flexibility test | — | flexible | flexible | flexible |

These tests were carried out on the non-treated original pipe and on stored pipes which had been exposed to an internal temperature of 95° C. (fluid filling) and an ambient temperature of 150° C. (air) for 500 hours or for 750 hours. The extreme conditions over the duration of 1000 hours comprised exposing the pipes to an internal temperature of 135° C. (fluid filling) and an ambient temperature of 150° C. (air). The two-layered pipes which had been fabricated according to the invention from the materials listed in Table 2 had withstood this test. Conditions to be satisfied naturally were not tested.

Applications of the two-layered plastic tubing piece according to the present invention comprise the manufacture of pipelines and/or hose lines which are installed and operated as pressurized fluid conduits (for liquids, steam or gases), in particular as coolant conduits, preferably in automobiles. The preferred use is therefore as a fluid conduit for automobiles. The use of the fluid conduit as a cooling line is particularly preferred.

What is claimed is:

1. A two-layered plastic tubing piece for pressurized fluid conduits comprising:
(a) an inner layer and an outer layer formed from a first mixture comprising an elastomeric co-polyolefin or a blend of a partially crystalline polyolefin and a synthetic olefin rubber, as well as a homopolyamide; and
(b) an outer layer formed from a second mixture comprising a homopolyamide,
wherein both mixtures from which the inner layer and the outer layer are formed, comprise the same homopolyamide, wherein an impact modifier from the class of acid-modified ethylene-a-olefin copolymers is added to each of these mixtures, and wherein the homopolyamide has a melting point of above 200° C. and has an average of at least 8 C atoms per monomer unit.

2. The two-layered plastic tubing piece of claim 1,
wherein the impact modifier in the mixture from which the inner layer is formed is present in a fraction of 2-55 wt. %, relative to 100 wt. % of the mixture.

3. The two-layered plastic tubing piece of claim 1,
wherein the impact modifier in the mixture from which the inner layer is formed is present in a fraction of 15-45 wt. %, relative to 100 wt. % of the mixture.

4. The two-layered plastic tubing piece of claim 1,
wherein the impact modifier in the mixture from which the inner layer is formed is present in a fraction of 25-35 wt. %, relative to 100 wt. % of the mixture.

5. The two-layered plastic tubing piece of claim 1,
wherein the impact modifier in the mixture from which the outer layer is formed is present in a fraction of 1-50 wt. %, relative to 100 wt. % of the mixture.

6. The two-layered plastic tubing piece of claim 1,
wherein the impact modifier in the mixture from which the outer layer is formed is present in a fraction of 10-30 wt. %, relative to 100 wt. % of the mixture.

7. The two-layered plastic tubing piece of claim 1,
wherein the impact modifier in the mixture from which the outer layer is formed is present in a fraction of 15-25 wt. %, relative to 100 wt. % of the mixture.

8. The two-layered plastic tubing piece of claim 1,
wherein the homopolyamide in the two mixtures from which the inner layer and the outer layer are formed is selected from the group PA 610, PA 612, PA 614 and PA 616.

9. The two-layered plastic tubing piece of claim 1,
wherein the homopolyamide in the two mixtures from which the inner layer and the outer layer are formed is PA 612.

10. The two-layered plastic tubing piece of claim 8 or 9,
wherein the homopolyamide in the mixture from which the inner layer is formed is present in a fraction of 2-55 wt. % relative to 100 wt. % of the mixture.

11. The two-layered plastic tubing piece of claim 8 or 9,
wherein the homopolyamide in the mixture from which the inner layer is formed is present in a fraction of 15-45 wt. % relative to 100 wt. % of the mixture.

12. The two-layered plastic tubing piece of claim 8 or 9,
wherein the homopolyamide in the mixture from which the inner layer is formed is present in a fraction of 25-35 wt. % relative to 100 wt. % of the mixture.

13. The two-layered plastic tubing piece of claim 8 or 9,
wherein the homopolyamide in the mixture from which the outer layer is formed is present in a fraction of at least 55 wt. % relative to 100 wt. % of the mixture.

14. The two-layered plastic tubing piece of claim 8 or 9,
wherein the homopolyamide in the mixture from which the outer layer is formed is present in a fraction of at least 65 wt. % relative to 100 wt. % of the mixture.

15. The two-layered plastic tubing piece of claim 8 or 9,
wherein the homopolyamide in the mixture from which the outer layer is formed is present in a fraction of at least 75 wt. % relative to 100 wt. % of the mixture.

16. The two-layered plastic tubing piece of claim 1,
wherein the impact modifier from the class of acid-modified ethylene-α-olefin copolymers in both mixtures from which the inner layer and the outer layer are formed is an ethylene propylene/ethylene butylene copolymer grafted with maleic acid anhydride.

17. The two-layered plastic tubing piece of claim 1,
wherein the elastomeric co-polyolefin or the blend of a partially crystalline polyolefin and a synthetic olefin rubber in the mixture from which the inner layer is formed is present in a fraction of 10-70 wt. % relative to 100 wt. % of the mixture.

18. The two-layered plastic tubing piece of claim 1,
wherein the elastomeric co-polyolefin or the blend of a partially crystalline polyolefin and a synthetic olefin rubber in the mixture from which the inner layer is formed is present in a fraction of 20-60 wt. % relative to 100 wt. % of the mixture.

19. The two-layered plastic tubing piece of claim 1,
wherein the elastomeric co-polyolefin or the blend of a partially crystalline polyolefin and a synthetic olefin rubber in the mixture from which the inner layer is formed is present in a fraction of 30-50 wt. % relative to 100 wt. % of the mixture.

20. The two-layered plastic tubing piece of claim 1,
wherein the first mixture from which the inner layer is formed comprises:
(i) 40 wt. % of an elastomeric co-polyolefin or a blend of a partially crystalline polyolefin and a synthetic olefin rubber;
(ii) 30 wt. % homopolyamide; and
(iii) 30 wt. % of ethylene propylene/ethylene butylene copolymer grafted with maleic acid anhydride;
and that the second mixture from which the outer layer is formed comprises:
(iv) 77.8 wt. % homopolyamide; and
(v) 20 wt. % of ethylene propylene/ethylene butylene copolymer grafted with maleic acid anhydride,
wherein the two mixtures contain additives selected from the group comprising antioxidants, stabilizers, dyes and soot.

21. The two-layered plastic tubing piece of claim 1,
wherein the synthetic olefin rubber is EPDM.

22. The two-layered plastic tubing piece of claim 21,
wherein the EPDM is cross-linked.

23. The two-layered plastic tubing piece of claim 1,
wherein the partially crystalline polyolefin is polypropylene.

24. The two-layered plastic tubing piece of claim 1,
wherein the blend of partially crystalline polyolefin and a synthetic olefin rubber is an EPDM/PP blend.

25. The two-layered plastic tubing piece of claim 1,
wherein it is formed as a pipeline and/or hose line.

26. The two-layered plastic tubing piece of claim 1,
wherein the two-layered plastic tubing piece is formed as a fluid conduit for automobiles.

27. The two-layered plastic tubing piece of claim 26,
wherein the fluid conduit is formed as a cooling line for automobiles.
